(19) United States
(12) Patent Application Publication
(10) Pub. No.: US 2011/0280140 A1
(43) Pub. Date: Nov. 17, 2011

(54) Alternate Transmission Scheme for High Speed Packet Access (HSPA)

(76) Inventors: Tom Chin, San Diego, CA (US); Guangming Shi, San Diego, CA (US); Kuo-Chun Lee, San Diego, CA (US)

(21) Appl. No.: 12/884,631

(22) Filed: Sep. 17, 2010

Related U.S. Application Data
(60) Provisional application No. 61/345,234, filed on May 17, 2010.

(51) Int. Cl. H04W 72/10; H04W 24/10; H04B 7/216

(52) U.S. Cl. 370/252; 370/329; 370/335

(57) ABSTRACT

Transmission of certain channels between a User Equipment (UE) and a Node B (NB) in High Speed Packet Access (HSPA) of a Time Division-Synchronous Code Division Multiple Access (TD-SCDMA) network may be scheduled during a UE's idle intervals. Scheduled transmissions during a UE's idle interval result in lost system resources because the transmissions do not occur. A NB may prevent conflicts between scheduled transmissions and a UE's idle period by prohibiting transfer of certain channels a predetermined number of radio frames before the UE's idle period. Alternatively, the NB may schedule transmission of certain channels with a predetermined delay to prevent the channels from being scheduled during the UE's idle period.

### CROSS REFERENCE TO RELATED APPLICATION

This application claims the benefit of U.S. provisional patent application No. 61/345,234 filed May 17, 2010, in the names of CHIN et al., the disclosure of which is expressly incorporated by reference in its entirety.

### BACKGROUND

1. Field

Aspects of the present disclosure relate, in general, to wireless communication systems, and more particularly, to facilitating high performance during High Speed Packet Access (HSPA) in a Time Division-Synchronous Code Division Multiple Access (TD-SCDMA) network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the disclosure, a method for communicating in a wireless network includes detecting a User Equipment (UE) having at least one idle interval. The method also includes prohibiting transmission of a high speed data grant to the UE within a predetermined time period prior to the idle interval(s).

In another aspect, a computer program product for communicating in a wireless network includes a computer-readable medium having code to detect a User Equipment (UE) having at least one idle interval. The medium also includes code to prohibit transmission of a high speed data grant to the UE within a predetermined time period prior to the idle interval(s).

In yet another aspect, an apparatus for communicating in a wireless network includes a processor and a memory coupled to the processor. The processor is configured to detect a User Equipment (UE) having at least one idle interval. The processor is further configured to prohibit transmission of a high speed data grant to the UE within a predetermined time period prior to the idle interval(s).

In a further aspect, an apparatus for communicating in a wireless network includes means for detecting a User Equipment (UE) having at least one idle interval. The apparatus also includes means for prohibiting transmission of a high speed data grant to the UE within a predetermined time period prior to the idle interval(s).

In one aspect, a method for communicating in a wireless network includes detecting a transmission to a User Equipment (UE) is scheduled during an idle interval of the UE. The method also includes delaying the transmission by a predetermined time period.

In another aspect, a computer program product for communicating in a wireless network includes a computer-readable medium having code to detect a transmission to a User Equipment (UE) is scheduled during an idle interval of the UE. The medium also includes code to delay the transmission by a predetermined time period.

In yet another aspect, an apparatus for communicating in a wireless network includes a processor and a memory coupled to the processor. The processor is configured to detect a transmission to a User Equipment (UE) is scheduled during an idle interval of the UE. The processor is also configured to delay the transmission by a predetermined time period.

In a further aspect, an apparatus for communicating in a wireless network includes means for detecting a transmission to a User Equipment (UE) is scheduled during an idle interval of the UE. The apparatus also includes means for delaying the transmission by a predetermined time period.

In one aspect, a method for communicating in a wireless network includes detecting a transmission to a Node B (NB) is scheduled during an idle interval of a User Equipment (UE). The method also includes delaying the transmission by a predetermined time period.

In another aspect, a computer program product for communicating in a wireless network includes a computer-readable medium having code to detect a transmission to a Node B (NB) is scheduled during an idle interval of a User Equipment (UE). The medium also includes code to delay the transmission by a predetermined time period.

In yet another aspect, an apparatus for communicating in a wireless network includes a processor and a memory coupled to the processor. The processor is configured to detect a transmission to a Node B (NB) is scheduled during an idle interval of a User Equipment (UE). The processor is further configured to delay the transmission by a predetermined time period.

In a further aspect, an apparatus for communicating in a wireless network includes means for detecting a transmission to a Node B (NB) is scheduled during an idle interval of a User Equipment (UE). The apparatus also includes means for delaying the transmission by a predetermined time period.

### BRIEF DESCRIPTION OF THE DRAWINGS

FIG. 1 is a block diagram illustrating an example of a telecommunications system.

FIG. 2 is a block diagram conceptually illustrating an example of a frame structure in a telecommunications system.

FIG. 3 is a block diagram of a Node B in communication with a user equipment in a radio access network.

FIG. 4 is a block diagram illustrating carrier frequencies in a multi-carrier TD-SCDMA communication system.

FIG. 5 shows a timing for HSDPA in a TD-SCDMA network according to one aspect.

FIG. 6 shows a timing for HSUPA in a TD-SCDMA network according to one aspect.

FIG. 7 shows a call flow for HSDPA in a TD-SCDMA network according to one aspect.

FIG. 8 shows a call flow for HSUPA in a TD-SCDMA network according to one aspect.

FIG. 9 shows a call flow for delaying transmissions in HSDPA according to one aspect.

FIG. 10 shows a call flow for delaying transmissions in HSUPA according to one aspect.

FIG. 11 shows a method for communicating in a wireless network according to one aspect.

FIG. 12 shows a method for communicating in a wireless network according to one aspect.

FIG. 13 shows a method for communicating in a wireless network according to one aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

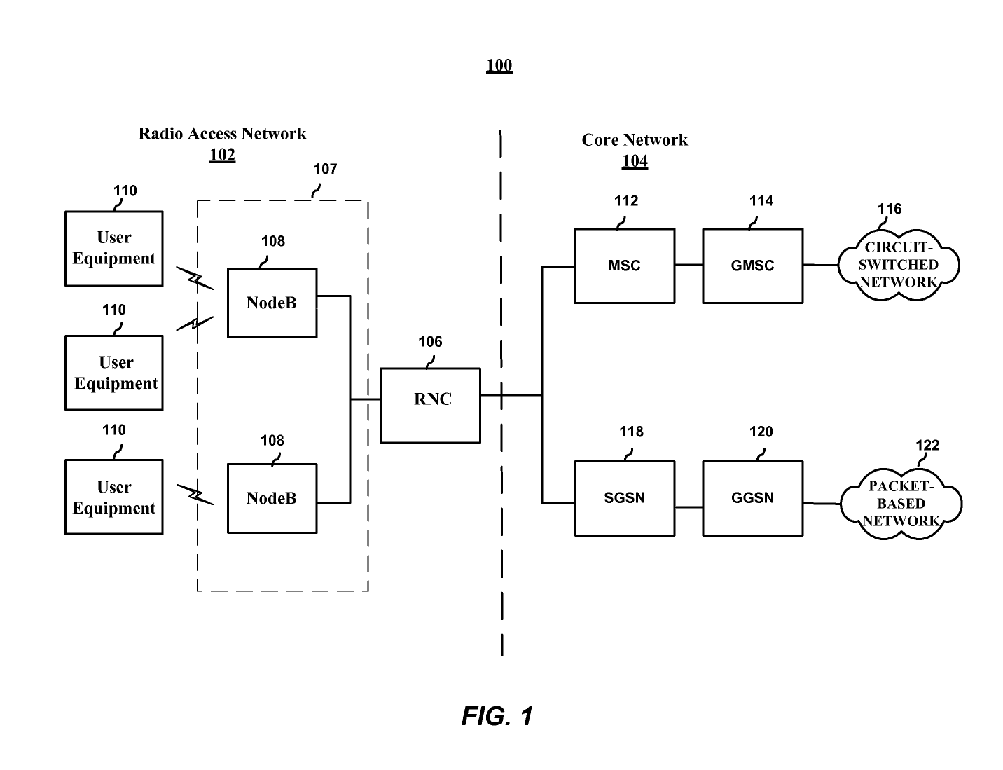

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (Radio Access Network) RAN 102 (e.g., UTRAN) that provides various wireless services including telephony, video, data, messaging, broadcasts, and/or other services. The RAN 102 may be divided into a number of Radio Network Subsystems (RNSs), such as an RNS 107, each controlled by a Radio Network Controller (RNC), such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces, such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a Base Station (BS), a Base Transceiver Station (BTS), a radio base station, a radio transceiver, a transceiver function, a Basic Service Set (BSS), an Extended Service Set (ESS), an Access Point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a Session Initiation Protocol (SIP) phone, a laptop, a notebook, a netbook, a smartbook, a Personal Digital Assistant (PDA), a satellite radio, a Global Positioning System (GPS) device, a multimedia device, a video device, a digital audio player (e.g., MP3 player), a camera, a game console, or any other similar functioning device. The mobile apparatus is commonly referred to as User Equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an Access Terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The Downlink (DL), also called the forward link, refers to the communication link from a Node B to a UE, and the Uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a Visitor Location Register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a Home Location Register (HLR) (not shown) containing subscriber data, such as the data reflecting the details of the services to which a particular user has subscribed. The HLR is also associated with an Authentication Center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a Serving GPRS Support Node (SGSN) 118 and a Gateway GPRS Support Node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a Time Division Duplexing (TDD), rather than a Frequency Division Duplexing (FDD) as used in many FDD mode UMTS/W-CDMA systems. TDD uses the same carrier frequency for both the Uplink (UL) and Downlink (DL) between a Node B 108 and a UE 110, but divides uplink and downlink transmissions into different time slots in the carrier.

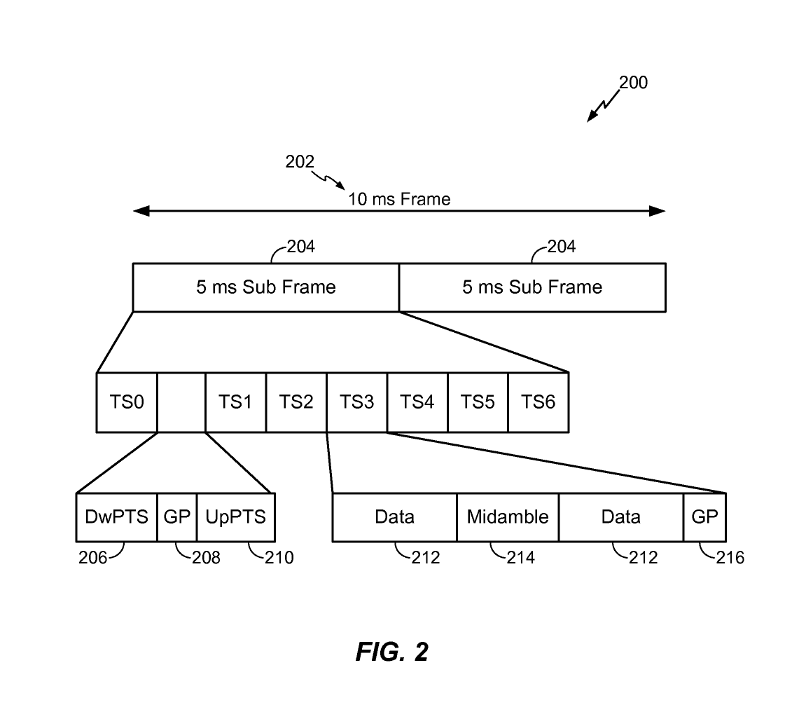

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A Downlink Pilot Time Slot (DwPTS) 206 (also known as the Downlink Pilot Channel (DwPCH)), a guard period (GP) 208, and an Uplink Pilot Time Slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a Guard Period (GP) 216. The midamble 214 may be used for features, such as channel estimation, while the GP 216 may be used to avoid inter-burst interference.

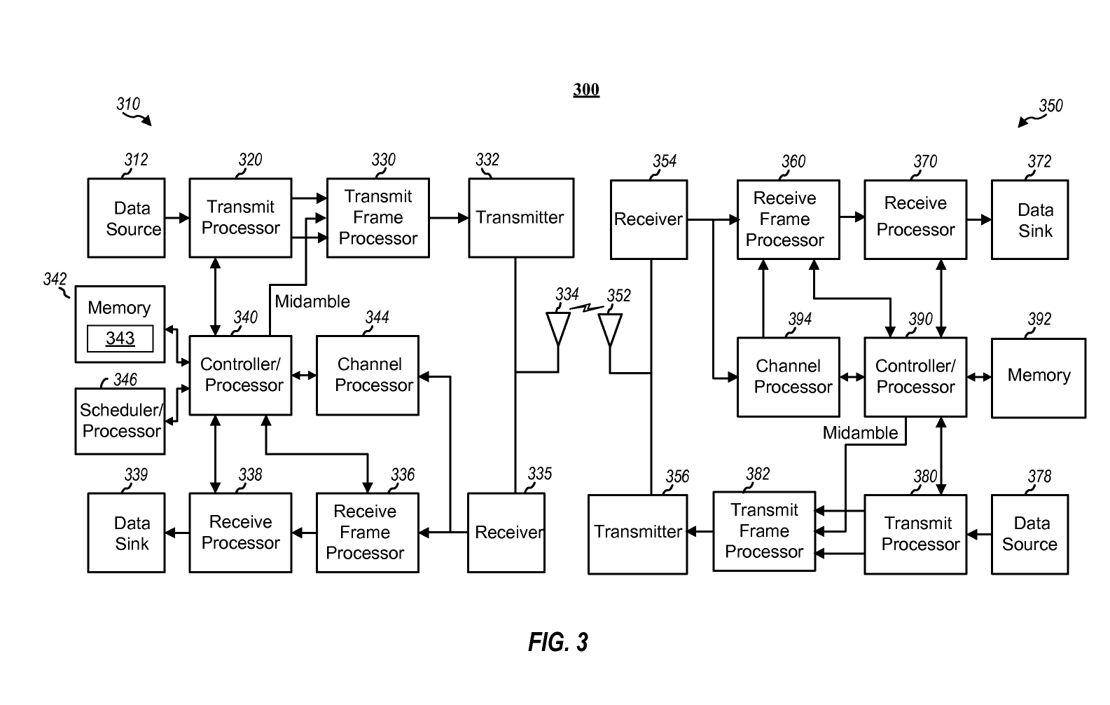

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide Cyclic Redundancy Check (CRC) codes for error detection, coding and interleaving to facilitate Forward Error Correction (FEC), mapping to signal constellations based on various modulation schemes (e.g., Binary Phase-Shift Keying (BPSK), Quadrature Phase-Shift Keying (QPSK), M-Phase-Shift Keying (M-PSK), M-Quadrature Amplitude Modulation (M-QAM), and the like), spreading with Orthogonal Variable Spreading Factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an Acknowledgement (ACK) and/or Negative Acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard, pointing device, track wheel, and the like). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the smart antennas 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor 340, respectively. If some of the frames were unsuccessfully decoded by the receive processor 338, the controller/processor 340 may also use an Acknowledgement (ACK) and/or Negative Acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. For example, the memory 342 of the Node B 310 includes a handover module 343, which, when executed by the controller/processor 340, the handover module 343 configures the Node B to perform handover procedures from the aspect of scheduling and transmission of system messages to the UE 350 for implementing a handover from a source cell to a target cell. A scheduler/processor 346 at the Node B 310 may be used to allocate resources to the UEs and schedule downlink and/or uplink transmissions for the UEs not only for handovers, but for regular communications as well.

In order to provide more capacity, the TD-SCDMA system may allow multiple carrier signals or frequencies. Assuming that N is the total number of carriers, the carrier frequencies may be represented by the set {F(i), i=0, 1, . . . , N−1} , where the carrier frequency, F(0), is the primary carrier frequency and the rest are secondary carrier frequencies. For example, a cell can have three carrier signals whereby the data can be transmitted on some code channels of a time slot on one of the three carrier signal frequencies.

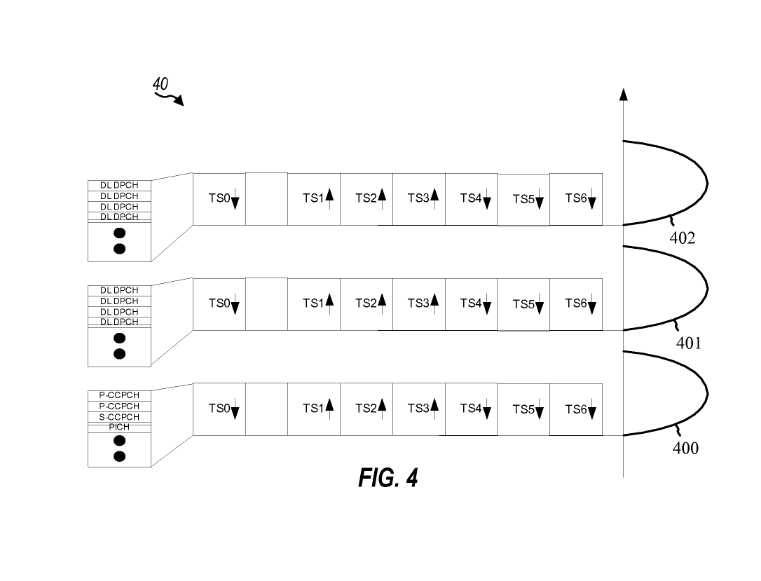

FIG. 4 is a block diagram illustrating carrier frequencies 40 in a multi-carrier TD-SCDMA communication system. The multiple carrier frequencies include a primary carrier frequency 400 (F(0)), and two secondary carrier frequencies 401 and 402 (F(1) and F(2)). In such multi-carrier systems, the system overhead may be transmitted on the first time slot (TS0) of the primary carrier frequency 400, including the Primary Common Control Physical Channel (P-CCPCH), the Secondary Common Control Physical Channel (S-CCPCH), the Pilot Indicator Channel (PICH), and the like. The traffic channels may then be carried on the remaining time slots (TS1-TS6) of the primary carrier frequency 400 and on the secondary carrier frequencies 401 and 402. Therefore, in such configurations, a UE will receive system information and monitor the paging messages on the primary carrier frequency 400 while transmitting and receiving data on either one or all of the primary carrier frequency 400 and the secondary carrier frequencies 401 and 402.

High Speed Downlink Packet Access (HSDPA) protocols in a TD-SCDMA network operate on several channels including a High-Speed Shared Control Channel (HS-SCCH), a High-Speed Physical Downlink Shared Channel (HS-PDSCH), and a High-Speed Shared Information Channel (HS-SICH). The HS-SCCH indicates a Modulation and Coding Scheme (MCS), channelization codes, and time slot resource information for data bursts on the HS-PDSCH. The HS-PDSCH is a downlink channel for the UE to receive data. The HS-SICH is an uplink channel for the UE to send Channel Quality Indicator (CQI) reports and Hybrid Automatic Repeat reQuest (HARQ) Acknowledgement/Negative Acknowledgement (ACK/NACK) for HS-PDSCH transmission.

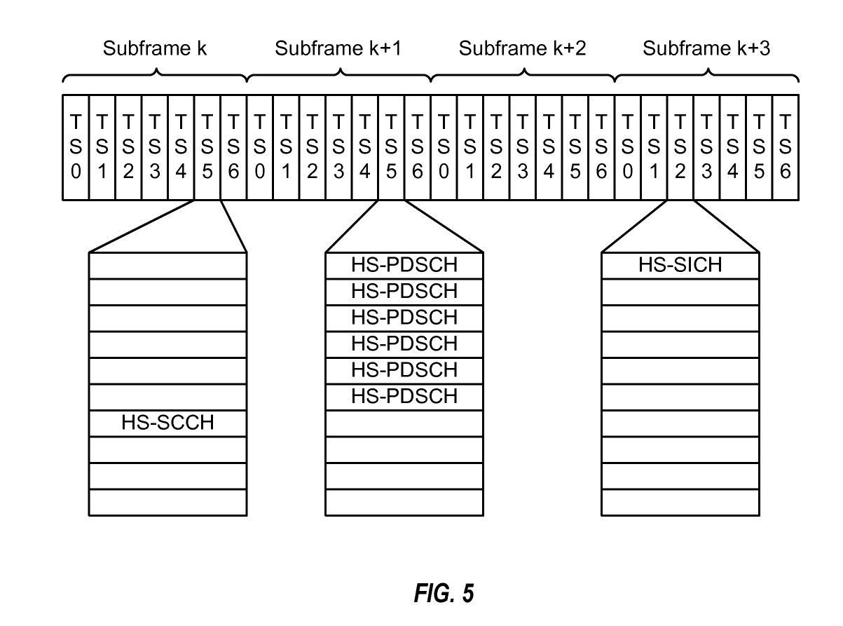

FIG. 5 shows a timing for HSDPA in a TD-SCDMA network according to one aspect. Each subframe (e.g., subframe k, k+1, k+2, and k+3) includes seven time slot periods (e.g., TS0, TS1, . . . , TS6). If during a subframe k, HS-SCCH is transmitted, then during a subframe k+1 HS-PDSCH is transmitted. Also, if during a subframe k, HS-SCCH is transmitted, then during a subframe k+3 HS-SICH is transmitted.

High Speed Uplink Packet Access protocols in a TD-SCDMA network operate on several channels including an Enhanced Dedicated Channel (E-DCH) Physical Uplink Channel (E-PUCH), an Enhanced Dedicated Channel (E-DCH) Absolute Grant Channel (E-AGCH), and an E-DCH Hybrid Automatic Repeat reQuest (ARQ) Acknowledgement Indicator Channel (E-HICH). The E-PUCH is an uplink channel for the UE to send data. The E-AGCH is a downlink channel for indicating the uplink absolute grant control information. The E-HICH is a downlink channel for sending HARQ ACK/NACK.

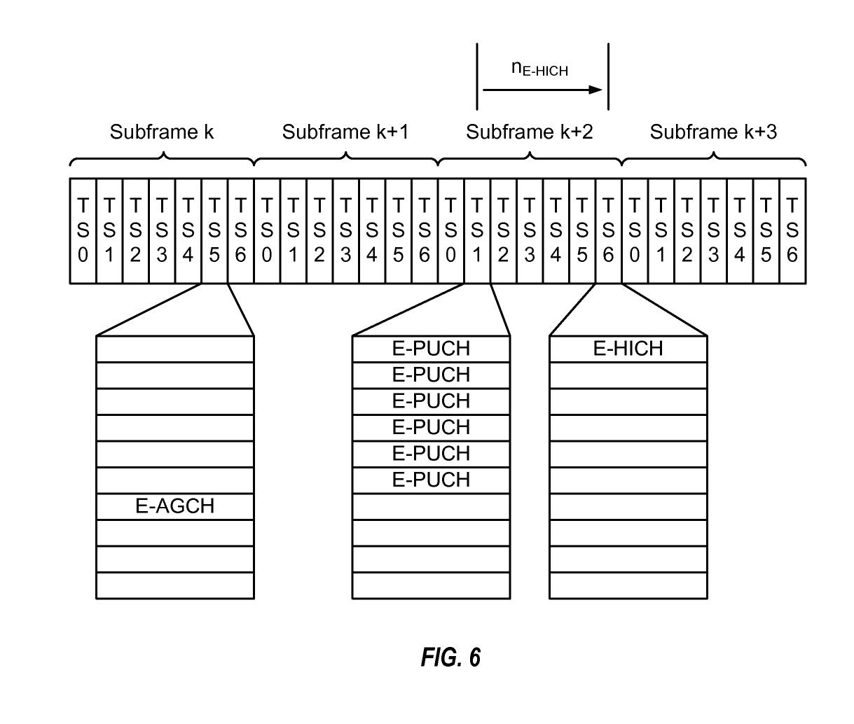

FIG. 6 shows a timing for HSUPA in a TD-SCDMA network according to one aspect. Each subframe (e.g., subframe k, k+1, k+2, and k+3) includes seven time slot periods (e.g., TS0, TS1, . . . , TS6). If during a subframe k, E-AGCH is transmitted, then during a subframe k+2 E-PUCH is transmitted. Also, if during a subframe k, E-AGCH is transmitted, then E-HICH is transmitted in a subframe k+2, k+3, or k+4, depending, in part, on a parameter n_{E-HICH}. According to one aspect, the n_{E-HICH} value is transmitted to the UE by a Node B and is an integer between 4 and 15. For example, in FIG. 6 n_{E-HICH} has a value of 5 time slots. Thus, the E-HICH is transmitted 5 time slots after the E-PUCH is transmitted. According to one aspect, the HARQ ACK transmission is synchronous such that the HARQ ACK transmission always occurs 11_{E-HICH} time slots after the E-PUCH burst transmission.

One method for performing inter-radio access technology (inter-RAT) measurements is based on an idle interval of the UE. For example, a Node B (NB) may include Idle Interval Information in a Measurement Control message transmitted to the UE to perform the inter-RAT measurement in a System Frame Number (SFN) defined by

offset=SFN mod (2^{m})

where m is an index of interval period.

For example, m may be an integer such as 2 or 3 corresponding to an interval period of 4 or 8 radio frames, respectively. Offset is an offset of an interval period, which may be, for example, an integer between 0 and 7.

Idle intervals scheduled for an HSPA-capable UE may result in conflicts with scheduled transmissions of HS-PDSCH, E-PUCH, HS-SICH, and E-HICH.

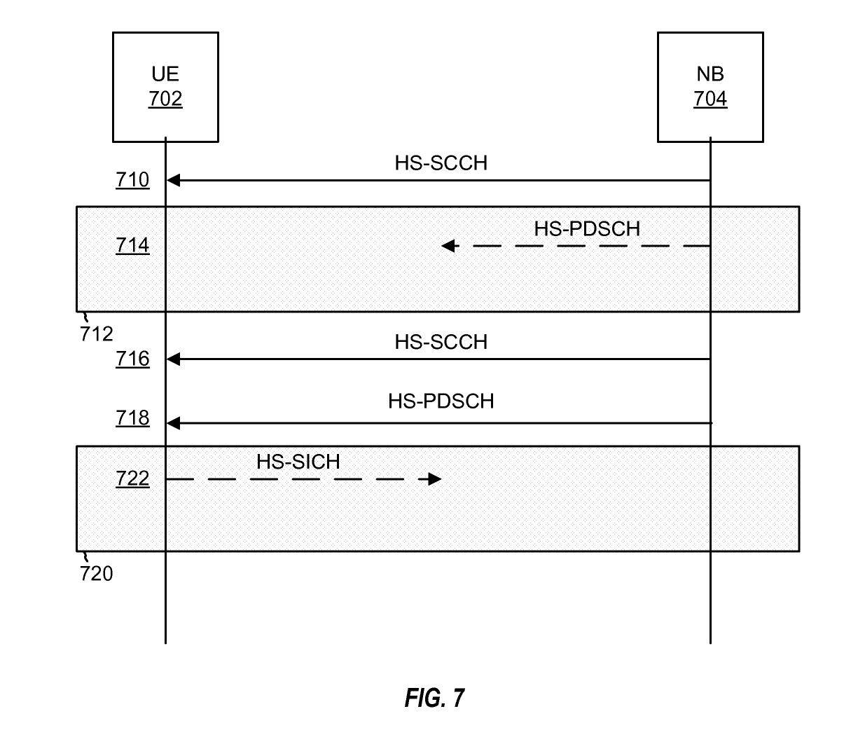

FIG. 7 shows a call flow for HSDPA in a TD-SCDMA network according to one aspect. At time 710 an HS-SCCH transmission is made from a Node B (NB) 704 to a UE 702. The UE 702 enters an idle interval 712 during which no transmissions to or from the UE 702 occur. As described above, a HS-PDSCH transmission occurs in a subframe k+1 after transmission of the HS-SCCH transmission in subframe k. If time 710 occurs close to the idle interval 712 the transmission of HS-PDSCH at time 714 may be scheduled during the idle interval 712, and thus will not occur.

In another example, at time 716 the Node B 704 transmits the HS-SCCH to the UE 702 in a subframe k, and transmits an HS-PDSCH to the UE 702 in a subframe k+1 (time 718). The UE 702 then enters an idle interval 720. As described above, an HS-SICH transmission occurs in a subframe k+3 after the HS-SCCH transmission. If time 716 occurs close to the idle interval 720 the transmission of HS-SICH at time 722 may be scheduled during the idle interval 720, and thus will not occur.

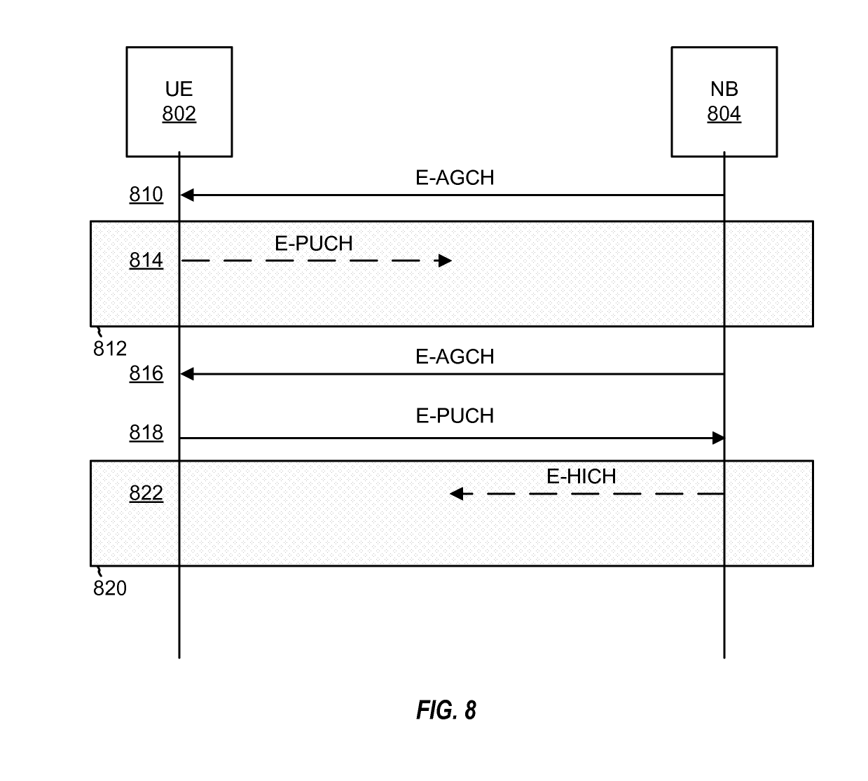

FIG. 8 shows a call flow for HSUPA in a TD-SCDMA network according to one aspect. At time 810 an E-AGCH is transmitted from a NB 804 to a UE 802. The UE 802 enters an idle interval 812 during which no transmission is made from the NB 804 to the UE 802. As described above, an E-PUCH transmission from the UE 802 to the NB 804 occurs in a subframe k+2 after transmission of the E-AGCH in subframe k. If time 810 occurs too close to the idle interval 812 the transmission of the E-PUCH at time 814 may be scheduled during the idle interval 812 and thus cannot occur.

In another example, at time 816 the NB 804 transmits the E-AGCH to the UE 802. At time 818 the UE 802 transmits to the NB 804 the E-PUCH. As described above, the E-HICH is transmitted from the NB 804 to the UE 802 n_{E-HICH} time slots after the E-PUCH. Depending on the value of n_{E-HICH}, time 822 for transmitting the E-HICH may occur during the idle interval 820 if time 816 occurs close to the idle interval 820, thereby preventing the transmission.

When data transmission or HARQ ACK transmissions overlap with an idle interval of a UE, system capacity may be lost because the allocated resources are not used. Thus, there is a need for efficiently scheduling transmissions in HSPA protocols of a TD-SCDMA network.

According to one aspect, a NB does not send any data allocations to a UE for a predetermined number of subframes prior to the UE's idle interval. For example, if the idle interval for a UE occurs at System Frame Number n (SFN=n), then the UE's idle interval occurs at system subframe 2*n and 2*n+1. In HSDPA, the NB may prohibit sending HS-SCCH transmissions to the UE at subframes 2*n−1, 2*n−2, and 2*n−3.

In HSUPA, the NB may prohibit sending E-AGCH transmissions to the UE based on the n_{E-HICH} value. For example, if the n_{E-HICH} value places the E-PUCH transmission in the same subframe as the E-HICH transmission, then the NB may prohibit transmission of E-AGCH to the UE in subframes 2*n−1 and 2*n−2. If the n_{E-HICH} value places the E-PUCH transmission in a subframe one subframe earlier than the E-HICH transmission, then the NB may prohibit transmission of the E-AGCH to the UE in subframes 2*n−1, 2*n−2, and 2*n−3. If the n_{E-HICH} value places the E-PUCH transmission in a subframe two subframes earlier than the E-HICH transmission, then the NB may prohibit transmission of E-AGCH transmission to the UE in subframes 2*n−1, 2*n−2, 2*n−3, and 2*n−4.

According to another aspect, timing for data allocation and HARQ ACK transmission is delayed by a predetermined number of radio frames to allow the UE to return from inter-RAT measurements. For example, the data allocation and HARQ ACK transmissions may be delayed one radio frame.

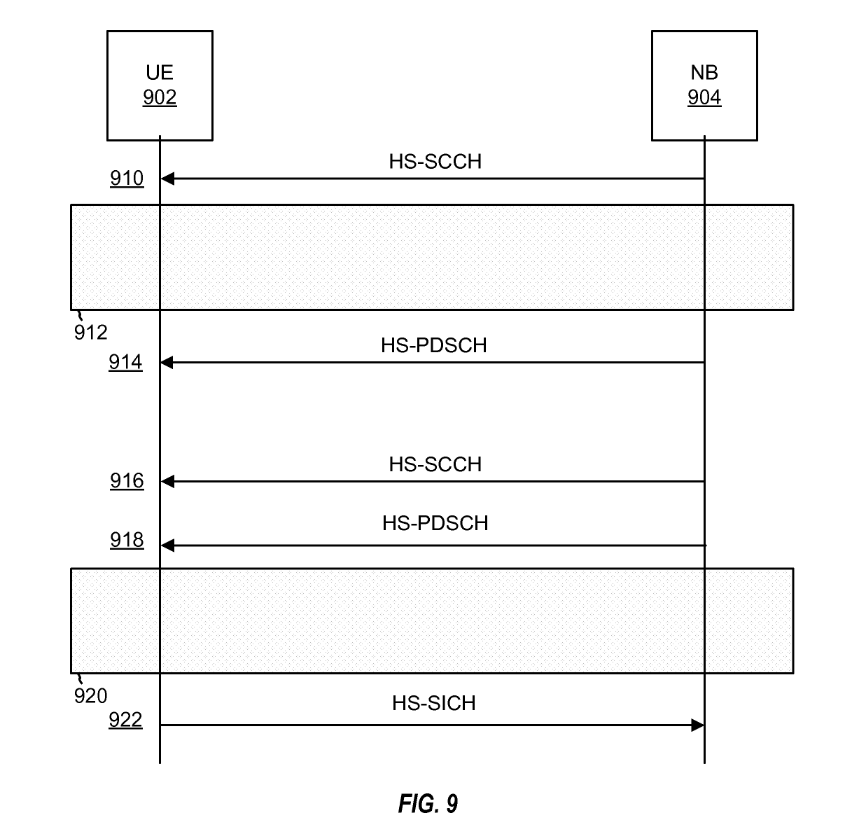

FIG. 9 shows a call flow for delaying transmissions in HSDPA according to one aspect. A Node B (NB) 904 transmits an HS-SCCH to a UE 902 at time 910. During an idle interval 912, no transmission occurs between the NB 904 and the UE 902 because the HS-PDSCH scheduled for transmission from the NB 904 to the UE 902 is delayed one radio frame. At time 914 the HS-PDSCH is transmitted one radio frame delayed from the NB 904 to the UE 902.

In another aspect, the HS-SICH transmission may be delayed one radio frame. For example, at time 916 the NB 904 transmits an HS-SCCH to the UE 902, and at time 918 the NB 904 transmits an HS-PDSCH to the UE 902. The UE then enters an idle interval 920. At time 922 the HS-SICH is transmitted from the UE 902 to the NB 904 after a one radio frame delay. The one radio frame delay of the HS-SICH transmission corresponds to the idle interval 920.

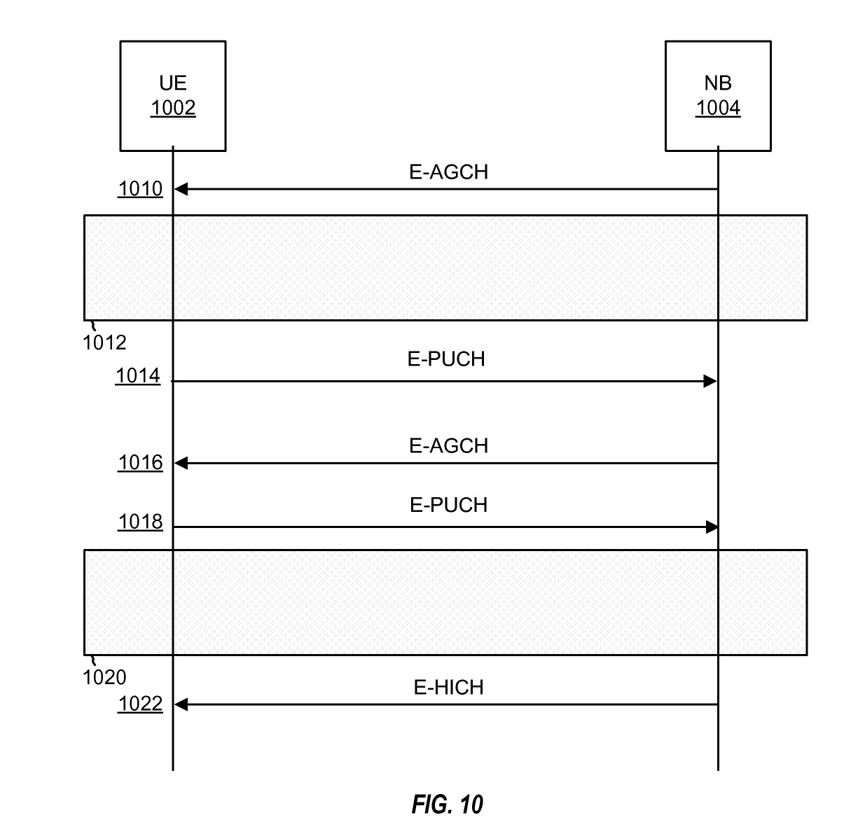

FIG. 10 shows a call flow for delaying transmissions in HSUPA according to one aspect. A Node B (NB) 1004 transmits an E-AGCH to a UE 1002 at time 1010. During an idle interval 1012, no transmission occurs between the NB 1004 and the UE 1002 because the E-PUCH scheduled for transmission from the UE 1002 to the NB 1004 is delayed one radio frame. At time 1014 the E-PUCH is transmitted one radio frame delayed from the UE 1002 to the NB 1004.

In another aspect, the E-HICH transmission may be delayed one radio frame. For example, at time 1016 the NB 1004 transmits an E-AGCH to the UE 1002, and at time 1018 the UE 1002 transmits an E-PUCH to the NB 1004. The UE then enters an idle interval 1020. At time 1022, the E-HICH is transmitted from the NB 1004 to the UE 1002 after a one radio frame delay. The one radio frame delay of the E-HICH transmission corresponds to the idle interval 1020.

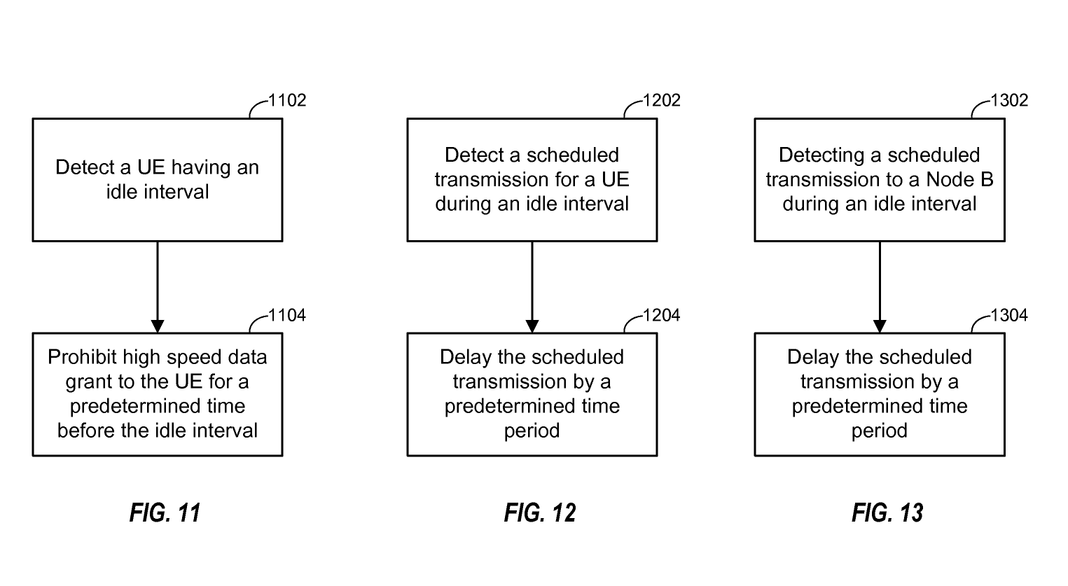

FIG. 11 shows a method for communicating in a wireless network according to one aspect. At block 1102 a Node B (NB) detects a User Equipment (UE) having at least one idle interval. At block 1104, the Node B prohibits transmission of a high speed data grant to the UE within a predetermined time period prior to the idle interval(s) of the UE.

FIG. 12 shows a method for communicating in a wireless network according to one aspect. At block 1202 a Node B (NB) detects a transmission to a User Equipment (UE) is scheduled during an idle interval of the UE. At block 1204 the NB delays the transmission by a predetermined time period.

FIG. 13 shows a method for communicating in a wireless network according to one aspect. At block 1302 a UE detects a transmission to a Node B (NB) is scheduled during an idle interval of the User Equipment (UE). At block 1304 the UE delays the transmission by a predetermined time period.

Although a delay of one radio frame is illustrated in FIGS. 9 and 10, a predetermined delay may be configured. By delaying transmission of HS-PDSCH, HS-SICH, E-PUCH, and/or E-HICH, the NB may prevent conflicts between a UE's idle interval and scheduled transmissions. Alternatively, the NB may prohibit scheduling of HS-SCCH, HS-PDSCH, E-AGCH, or E-PUCH in certain frames before a UE's idle interval to prevent conflict between the UE's idle interval and scheduled transmissions.

Several aspects of a telecommunications system has been presented with reference to TD-SCDMA. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Global System for Mobile Communications (GSM), Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, Digital Signal Processor (DSP), a Field-Programmable Gate Array (FPGA), a Programmable Logic Device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., Compact Disc (CD), Digital Versatile Disc (DVD)), a smart card, a flash memory device (e.g., card, stick, key drive), Random Access Memory (RAM), Read Only Memory (ROM), Programmable ROM (PROM), Erasable PROM (EPROM), Electrically Erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for communicating in a wireless network, comprising:
detecting a User Equipment (UE) having at least one idle interval; and
prohibiting transmission of a high speed data grant to the UE within a predetermined time period prior to the at least one idle interval of the UE.

2. The method of claim 1, wherein the predetermined time period is associated with a high speed transaction.

3. The method of claim 1, wherein the high speed data grant is at least one of a High Speed Downlink Packet Access (HSDPA) grant and a High Speed Uplink Packet Access (HSUPA) grant.

4. The method of claim 1, wherein the wireless network is a Time Division-Synchronous Code Division Multiple Access (TD-SCDMA) network.

5. The method of claim 1, wherein prohibiting transmission comprises prohibiting transmission of an Enhanced Dedicated Channel (E-DCH) Absolute Grant Channel (E-AGCH) in a number of subframes before the at least one idle interval based, in part, on an E-DCH Hybrid ARQ Acknowledgement Indicator Channel (E-HICH) parameter value.

6. The method of claim 1, wherein the at least one idle interval is a period during which the UE performs inter-Radio Access Technology (inter-RAT) measurements.

7. A computer program product for communicating in a wireless network, comprising:
a computer-readable medium comprising:
code to detect a User Equipment (UE) having at least one idle interval; and
code to prohibit transmission of a high speed data grant to the UE within a predetermined time period prior to the at least one idle interval of the UE.

8. The computer program product of claim 7, wherein the code to prohibit transmission prohibits transmission during a predetermined time period associated with a high speed transaction.

9. The computer program product of claim 7, wherein the code to prohibit transmission prohibits at least one of a High Speed Downlink Packet Access (HSDPA) grant and a High Speed Uplink Packet Access (HSUPA) grant.

10. The computer program product of claim 7, wherein the wireless network is a Time Division-Synchronous Code Division Multiple Access (TD-SCDMA) network.

11. The computer program product of claim 7, wherein the code to prohibit transmission prohibits transmission of an Enhanced Dedicated Channel (E-DCH) Absolute Grant Channel (E-AGCH) in a number of subframes before the at least one idle interval based, in part, on an E-DCH Hybrid ARQ Acknowledgement Indicator Channel (E-HICH) parameter value.

12. The computer program product of claim 7, wherein the at least one idle interval is a period during which the UE performs inter-Radio Access Technology (inter-RAT) measurements.

13. An apparatus for communicating in a wireless network, comprising:
at least one processor; and
a memory coupled to the at least one processor,
wherein the at least one processor is configured:
to detect a User Equipment (UE) having at least one idle interval; and
to prohibit transmission of a high speed data grant to the UE within a predetermined time period prior to the at least one idle interval of the UE.

14. The apparatus of claim 13, wherein the at least one processor is configured to prohibit transmission during a predetermined time period associated with a high speed transaction.

15. The apparatus of claim 13, wherein the at least one processor is configured to prohibit transmission of at least one of a High Speed Downlink Packet Access (HSDPA) grant and a High Speed Uplink Packet Access (HSUPA) grant.

16. The apparatus of claim 13, wherein the wireless network is a Time Division-Synchronous Code Division Multiple Access (TD-SCDMA) network.

17. The apparatus of claim 13, wherein the at least one processor is configured to prohibit transmission of an Enhanced Dedicated Channel (E-DCH) Absolute Grant Channel (E-AGCH) in a number of subframes before the at least one idle interval based, in part, on an E-DCH Hybrid ARQ Acknowledgement Indicator Channel (E-HICH) parameter value.

18. The apparatus of claim 13, wherein the at least one idle interval is a period during which the UE performs inter-Radio Access Technology (inter-RAT) measurements.

19. An apparatus for communicating in a wireless network, comprising:
means for detecting a User Equipment (UE) having at least one idle interval; and
means for prohibiting transmission of a high speed data grant to the UE within a predetermined time period prior to the at least one idle interval of the UE.

20. The apparatus of claim 19, wherein the prohibiting means prohibits transmission during a predetermined time period associated with a high speed transaction.

21. The apparatus of claim 19, wherein the prohibiting means prohibits at least one of a High Speed Downlink Packet Access (HSDPA) grant and a High Speed Uplink Packet Access (HSUPA) grant.

22. The apparatus of claim 19, wherein the wireless network is a Time Division-Synchronous Code Division Multiple Access (TD-SCDMA) network.

23. The apparatus of claim 19, wherein the prohibiting means prohibits an Enhanced Dedicated Channel (E-DCH) Absolute Grant Channel (E-AGCH) in a number of subframes before the at least one idle interval based, in part, on an E-DCH Hybrid ARQ Acknowledgement Indicator Channel (E-HICH) parameter value.

24. The apparatus of claim 19, wherein the at least one idle interval is a period during which the UE performs inter-Radio Access Technology (inter-RAT) measurements.

25. A method for communicating in a wireless network, comprising:
detecting a transmission to a User Equipment (UE) is scheduled during an idle interval of the UE; and
delaying the transmission by a predetermined time period.

26. The method of claim 25, wherein the transmission comprises data and an acknowledgement.

27. The method of claim 25, wherein the wireless network is a Time Division-Synchronous Code Division Multiple Access (TD-SCDMA) network.

28. A computer program product for communicating in a wireless network, comprising:
a computer-readable medium comprising:
code to detect a transmission to a User Equipment (UE) is scheduled during an idle interval of the UE; and
code to delay the transmission by a predetermined time period.

29. The computer program product of claim 28, wherein the code to delay the transmission delays transmission of data and an acknowledgement.

30. The computer program product of claim 28, wherein the wireless network is a Time Division-Synchronous Code Division Multiple Access (TD-SCDMA) network.

31. An apparatus for communicating in a wireless network, comprising:
at least one processor; and
a memory coupled to the at least one processor,
wherein the at least one processor is configured:
to detect a transmission to a User Equipment (UE) is scheduled during an idle interval of the UE; and
to delay the transmission by a predetermined time period.

32. The apparatus of claim 31, wherein the at least one processor is configured to delay transmission of data and an acknowledgement.

33. The apparatus of claim 31, wherein the wireless network is a Time Division-Synchronous Code Division Multiple Access (TD-SCDMA) network.

34. An apparatus for communicating in a wireless network, comprising:
means for detecting a transmission to a User Equipment (UE) is scheduled during an idle interval of the UE; and
means for delaying the transmission by a predetermined time period.

35. The apparatus of claim 34, wherein the delaying means delays transmission of data and an acknowledgement.

36. The apparatus of claim 34, wherein the wireless network is a Time Division-Synchronous Code Division Multiple Access (TD-SCDMA) network.

37. A method for communicating in a wireless network, comprising:
detecting a transmission to a Node B (NB) is scheduled during an idle interval of a User Equipment (UE); and
delaying the transmission by a predetermined time period.

38. The method of claim 37, wherein the transmission comprises data and an acknowledgement.

39. The method of claim 37, wherein the wireless network is a Time Division-Synchronous Code Division Multiple Access (TD-SCDMA) network.

40. A computer program product for communicating in a wireless network, comprising:
a computer-readable medium comprising:
code to detect a transmission to a Node B (NB) is scheduled during an idle interval of a User Equipment (UE); and
code to delay the transmission by a predetermined time period.

41. The computer program product of claim 40, wherein the code to delay the transmission delays transmission of data and an acknowledgement.

42. The computer program product of claim 40, wherein the wireless network is a Time Division-Synchronous Code Division Multiple Access (TD-SCDMA) network.

43. An apparatus for communicating in a wireless network, comprising:
at least one processor; and
a memory coupled to the at least one processor,
wherein the at least one processor is configured:
to detect a transmission to a Node B (NB) is scheduled during an idle interval of a User Equipment (UE); and
to delay the transmission by a predetermined time period.

44. The apparatus of claim 43, wherein the at least one processor is configured to delay the transmission of data and an acknowledgement.

45. The apparatus of claim 43, wherein the wireless network is a Time Division-Synchronous Code Division Multiple Access (TD-SCDMA) network.

46. An apparatus for communicating in a wireless network, comprising:
means for detecting a transmission to a Node B (NB) is scheduled during an idle interval of a User Equipment (UE); and
means for delaying the transmission by a predetermined time period.

47. The apparatus of claim 46, wherein the delaying means delays data and an acknowledgement.

48. The apparatus of claim 46, wherein the wireless network is a Time Division-Synchronous Code Division Multiple Access (TD-SCDMA) network.
